(19) United States
(12) Patent Application Publication
(10) Pub. No.: US 2023/0000027 A1
(43) Pub. Date: Jan. 5, 2023

(54) PRESSURE ATMOSPHERE ROOM

(71) Applicant: Grow Controlled, LLC, Sparta, MI (US)

(72) Inventors: James C. Schaefer, Rockford, MI (US); Dan Boozer, Rockford, MI (US); Todd Bell, Las Vegas, NV (US); Samuel Schaefer, Rockford, MI (US)

(21) Appl. No.: 17/779,862

(22) PCT Filed: Dec. 4, 2020
(86) PCT No.: PCT/US2020/063189

§ 371 Date: May 25, 2022

Related U.S. Application Data
(60) Provisional application No. 62/943,590, filed on Dec. 4, 2019.

(51) Int. Cl. A01G 9/18; A01G 22/60; A01G 9/24

(52) U.S. Cl. CPC A01G 9/18; A01G 22/60; A01G 9/249

(57) ABSTRACT

A method of preparing a flowering plant product in hypobarically- and hypoxically-controlled atmospheres is disclosed. The method includes providing a simulated high-altitude controlled atmosphere (SHACA) room having a chamber, a plant support structure disposed within the chamber, and a microclimate control system operable to establish and maintain within the chamber a simulated high-altitude environment having an oxygen (O2) partial pressure of less than 20 kRa and, optionally, an overall pressure of less than 97 kPa. The method also includes disposing a flowering plant on the plant support structure, and exposing the flowering plant to the simulated high-altitude environment within the chamber. A simulated high-altitude CA room for cultivating and processing flowering plants in a hypobaric and hypoxic atmosphere is also provided.

### CROSS-REFERENCE TO RELATED APPLICATIONS

This application claims priority to and all of advantages of U.S. Prov. Appl. No. 62/943,590 filed on 4 Dec. 2019, the contents of which is hereby incorporated by reference.

### FIELD OF THE INVENTION

The present invention relates to horticultural methods and, more particularly, to methods of preparing flowering plant products in simulated high-altitude environments and controlled atmosphere systems for use in the same.

### BACKGROUND OF THE INVENTION

Controlled atmosphere (CA) rooms are commonly used to store fruits, vegetables, and other commodities that benefit from storage in environments where certain factors, such as temperature and atmospheric composition, can be controlled to extend the life of the items. CA rooms typically include systems for monitoring and controlling temperature and atmospheric conditions (e.g. oxygen, carbon dioxide and nitrogen levels) in a gastight space. The atmospheric control systems often operate by repeatedly sampling gas levels within the CA room and adding or removing gases to maintain the atmosphere at one or more desired set points.

In addition to use as storage spaces, CA rooms can also be used in the preparation of plant products. For example, CA rooms in the form of greenhouses are used to germinate and cultivate many different varieties of plants, especially those not suitable for growth in a normal climate. Such specialized CA rooms are often used to maintain a compact growing area, preserve natural resources, minimize human resources, decrease crop loss from climate fluctuations and/or disease, etc. CA rooms are also used as dry rooms to cure certain foodstuffs, such as meats and cheeses, where the rate of moisture loss is important due to the drying process requiring the loss of free water from within the product. In particular, if available water is removed from a product too rapidly (e.g. from vapor pressure in the dry room being too low compared to a vapor pressure within the product), the outer layer of the product may become too dry, in turn reducing the rate at the moisture can leave the center of the product, or trapping moisture in the center of the product all together. As such, CA rooms provide a benefit over traditional dry rooms in terms of the selective atmospheric control offered, which allows for increased control in balancing the product vapor pressure and room vapor pressure and, ultimately, the rate at which moisture is removed from a product.

Unfortunately, conventional CA rooms are limited with regard to certain conditions that may be employed, especially in CA rooms equipped for housing live plants. For example, while ventilation systems including blowers and fans are frequently employed in CA rooms, and may provide negative pressure atmospheres, conventional CA rooms are not suitable to achieve low-pressure environments. This is not surprising, as controlled low-pressure (i.e., “hypobaric”) environments are not present in terrestrial ecosystems. In fact, most plants cannot survive in natural low-pressure environments, which only occur at high elevations (e.g. above ˜8,000 feet above sea level), as evidenced by the “tree line” found on many mountains or other raised landforms. Conventional CA are also not generally suitable for cultivating plants in a prolonged low-oxygen (i.e., “hypoxic”) environment. This is also not surprising, as although some CA rooms utilize temporary hypoxic conditions in sterilization protocols (e.g. to inhibit microbial growth), hypoxic and anoxic conditions are stressors known to inhibit critical plant functions such as nutrient and water uptake. Complicating matters further, it has been reported that a reduced partial pressure of oxygen (e.g. hypoxia) is a major contributor to plant stress in in hypobaric conditions.

### SUMMARY OF THE INVENTION

A method of preparing a flowering plant product in a hypobaric and hypoxic atmosphere (the “preparation method”) is provided. The preparation method includes providing a controlled atmosphere (CA) room, which defines an interior chamber containing a microclimate and has a microclimate control system operatively coupled thereto. The microclimate control system is configured to establish and maintain within the chamber a simulated high-altitude environment having an oxygen (O2) partial pressure of less than 20 kPa, and optionally an overall pressure of less than 97 kPa. The preparation method also includes disposing a flowering plant on a plant support structure within the chamber, and exposing the flowering plant to the simulated high-altitude environment.

The flowering plant product prepared by the preparation method may be a live flowering plant or a post-harvest product prepared from a flowering plant. For example, in some embodiments, a flowering plant seedling is disposed in the chamber and exposed to the simulated high-altitude environment during a growth phase, to provide a live flowering plant as the product. In particular embodiments, a harvested flowering plant, or a portion thereof, is disposed in the chamber and exposed to the simulated high-altitude environment during a drying phase. In specific embodiments, a dried harvested flowering plant is disposed in the chamber and exposed to the simulated high-altitude environment during a curing phase.

A simulated high-altitude controlled atmosphere (SHACA) room for cultivating and processing flowering plants in a hypobaric and hypoxic atmosphere is also provided, and may be utilized in the preparation method. The SHACA room includes a gastight enclosure defining a chamber, and a plant support structure disposed within the chamber for supporting a flowering plant. The SHACA room also includes a pump for changing and removing air from the chamber, a gas supply for selectively supplying nitrogen (N2), oxygen (O2), and/or carbon dioxide (CO2) to the chamber, and an active microclimate control operatively coupled to the pump and the gas supply. The active microclimate control includes at least one sensor operable to sense microclimate conditions within the chamber, including the pressure, oxygen (O2) content, and carbon dioxide (CO2) content therein. The microclimate control also includes a controller, which is configured to establish and maintain a simulated high-altitude environment within the chamber, based at least in part on one or more sensed microclimate conditions provided by the at least one sensor. In particular, the simulated high-altitude environment comprises a nitrogen (N2) environment having an oxygen (O2) partial pressure of less than 20 kPa, and optionally an overall pressure of less than 97 kPa.

These and other features and advantages of the present disclosure will become apparent from the following description of particular embodiments, when viewed in accordance with the accompanying drawings and appended claims.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a diagrammatic representative view of a CA room incorporating a microclimate control system in accordance with an embodiment of the present invention showing immature flowering plants being cultivated.

FIG. 2 is a diagrammatic representative view of a CA room similar to FIG. 1, but with mature flowering plants being cultivated.

FIG. 3 is a diagrammatic representative view of another CA room incorporating an embodiment of a plant support structure for drying harvested flowering plants.

FIG. 4 is a diagrammatic representative view of a CA room incorporating an alternative embodiment of a plant support structure for curing harvested or partially-processed flowering plants.

FIG. 5 is a diagrammatic representative view of a CA room incorporating an alternative embodiment of the microclimate control system.

FIG. 6 is a diagrammatic representative view of another CA room incorporating another alternative embodiment of the microclimate control system.

### DETAILED DESCRIPTION OF THE INVENTION

The present invention provides a method of preparing a flowering plant product (hereinafter, the “preparation method”).

The preparation method includes providing a controlled atmosphere room having a chamber, a plant support structure disposed within the chamber, and a microclimate control system. The microclimate control system is operable to establish and maintain within the chamber a simulated high-altitude environment having an oxygen (O2) partial pressure of less than 20 kPa, and optionally an overall pressure of less than 97 kPa. The preparation method also includes disposing a flowering plant on the plant support structure, and exposing the flowering plant to the simulated high-altitude environment within the chamber via the microclimate control system.

Flowering plants suitable for use in the preparation method are not particularly limited and may include, for example, plants of the genus Cannabis, including species of Cannabis sativa, Cannabis indica, and Cannabis ruderalis, as well as derivatives, variants, and combinations thereof. Other flowering plants may also be utilized, such as those from which one or more secondary metabolites may be extracted.

As will be appreciated from the description below, exposing the flowering plant to the particular high-altitude environmental conditions for a sufficient treatment period may be used to regulate or otherwise influence certain metabolic processes within the plant (i.e., as compared to a substantially similar flowering plant not exposed to the high-altitude environmental conditions), allowing for the preparation of flowering plant products in greater yields, shorter production periods, and/or with compositions not otherwise attainable via conventional preparation processes.

The preparation method utilizes a controlled atmosphere (CA) room and, in particular, a CA room configured to simulate a high-altitude atmosphere with respect to one or more particular environmental conditions (e.g. pressure, gas content, humidity, etc.). A particular such CA room, designated herein as a simulated high-altitude controlled atmosphere (SHACA) room, is provided and described further below as one aspect of the present invention.

In particular, with reference to the Figures, where like numerals indicate corresponding parts throughout the several views, an exemplary SHACA room suitable for use in the preparation method is illustrated and generally designated at 10. As shown in the exemplary embodiments, the SHACA room 10 includes an enclosure 12 that defines an interior chamber. The enclosure 12 is configured to be operable in an airtight configuration to increase the efficiency and control of the various systems described below. As such, while the enclosure 12 may comprise any number of ports or other openings, such openings are typically hermetically sealed, or sealable via a closure or covering, such as a door 14 as shown in the exemplary embodiments. The SHACA room 10 also includes a computer-controlled microclimate control system 16 (hereinafter, the “control system 16”), which is connected to an input/output (I/O) device, such as a workstation or a tablet 18, and is described in further detail below. In certain embodiments, the SHACA room 10 is but one room among a series of SHACA rooms of a facility (not shown). In such embodiments, each SHACA room 10 may be independently configured and controlled and thus include a unique enclosure 12, microclimate control system 16, etc. However, in some such embodiments, a central controller 20 may be utilized, e.g. to monitor the status of the individual SHACA rooms 10, prioritize processing/utilization of contents from among the various SHACA rooms 10, collectively control certain parameters of multiple SHACA rooms 10 or the facility as a whole, etc. In addition to the particular components, systems, and configurations described herein, the SHACA room 10 and certain components thereof (e.g. the enclosure 12, the control system 16, etc.) may include one or more of the systems and/or configurations disclosed in U.S. Pat. Nos. 8,551,215, 10,143,210, and 10,184,580 to Schaefer et al., the contents of which are herein incorporated by reference in their entirety. Likewise, the SHACA room 10 may comprise other systems and components, such as a self-contained cooling and ventilation (HVAC) system including one or more air moving/circulation devices (e.g. fans, blowers, etc.), conduits (e.g. tubes, ducts, etc.), conditioners (e.g. humidifiers, dehumidifiers, heaters, coolers, etc.), filters (e.g. carbon filters, HEPA filters, etc.), sensors (e.g. sensors for odor, humidity, temperature, pressure, oxygen (O2), carbon dioxide (CO2), ethylene, etc.), and/or a lighting system for artificial illumination including one or more lamps (e.g. grow lamps, UV lights, etc.), optionally coupled to a timer for operating the lamps in on/off cycles to simulate daylight hours.

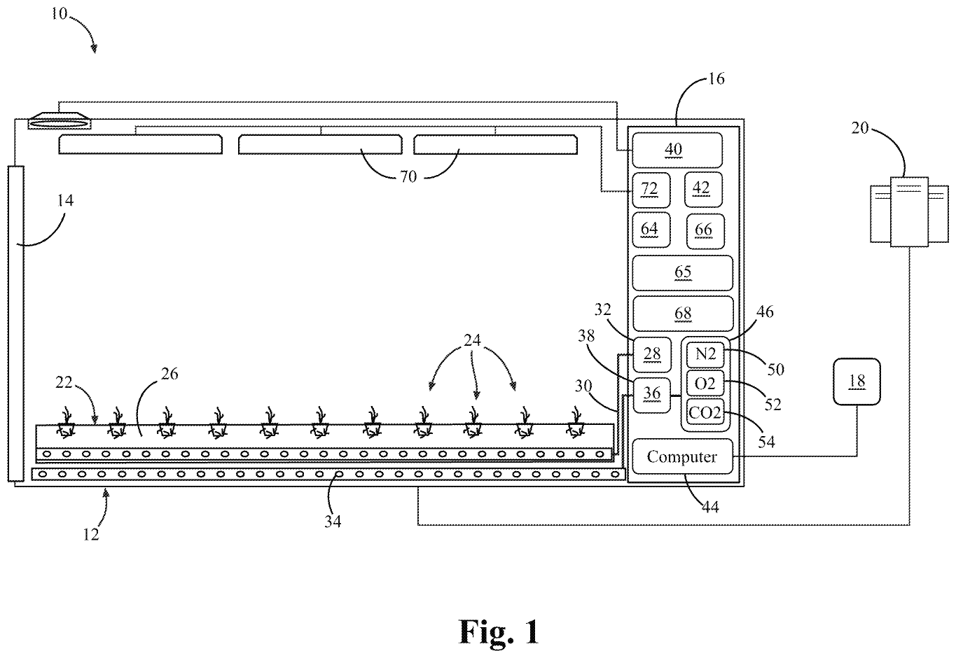

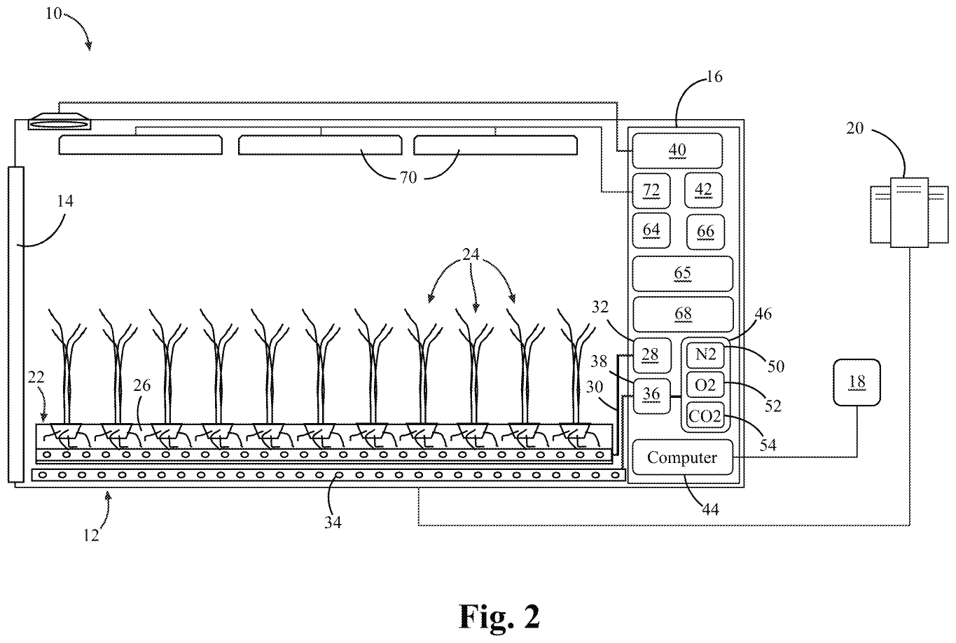

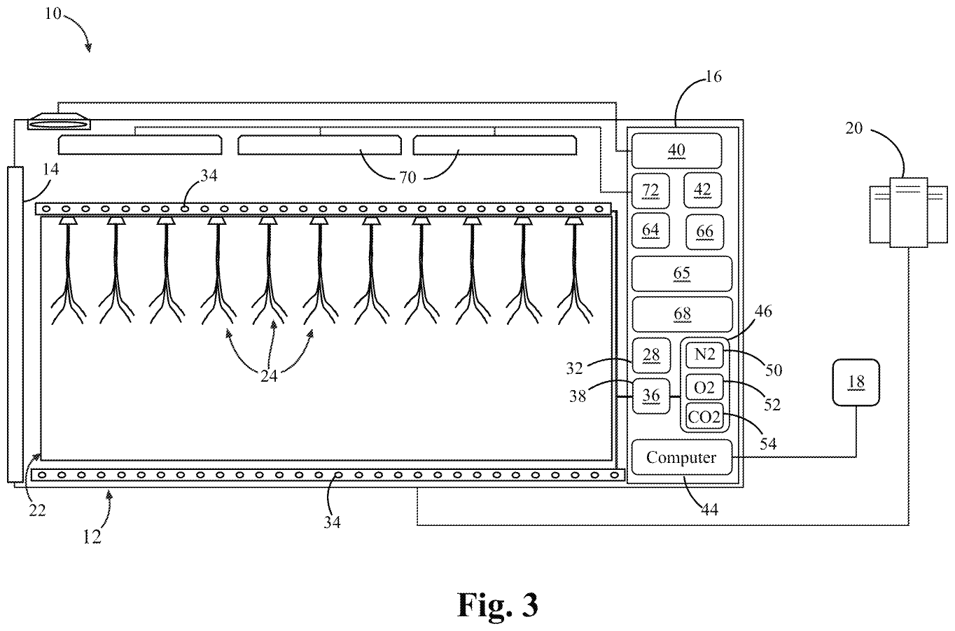

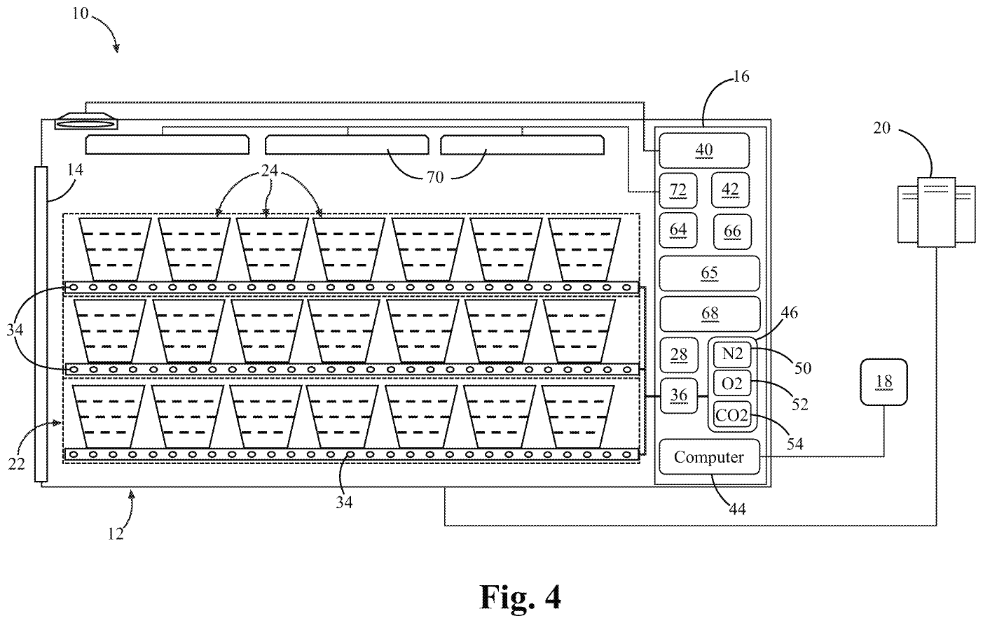

The SHACA room 10 includes a plant support structure 22 (hereinafter, the “support structure 22”) disposed within the chamber of the enclosure 12. The support structure 22 is adapted for supporting a flowering plant, or a plurality of flowering plants, as shown and designated at 24 in FIGS. 1-4. The support structure 22 may include a table, rack, shelf, or combinations thereof, for example to support growing containers (e.g. pots, trays, troughs, etc.), drying containers (e.g. baskets, perforated bins, etc.), hangers, and the like. For example, in the exemplary embodiments shown in FIGS. 1-2, the support structure 22 is implemented as a tray or trough to support a growth media 26 (e.g. soil, water, etc.) in which the roots of the plants 24 are disposed. In these embodiments, the growth media 26 may be supplied to the support structure 22 from a media supply 28 (e.g. a tank, hose, reservoir, etc.), for example via hose or tubing 30. As such, the support structure 22 may comprise, or be adapted for use with, a growth support or nutrient management system 32, such as a hydroponic, aeroponic, and/or irrigation system. In other embodiments, such as those exemplified by the SHACA room 10 shown in FIG. 4, the support structure 22 comprises a series of drying racks comprising vents or outlets 34 coupled to a blower 36 of an air circulation system 38, as described in further detail below.

As introduced above, the SHACA room 10 includes the control system 16. The control system 16 is adapted to control (i.e., establish, adjust, maintain, etc.) the atmosphere within the enclosure 12, and is operable to simulate a high-altitude environment with respect to one or more particular conditions (e.g. pressure, gas content, etc.). In the illustrated embodiment, the control system 16 is adapted to adjust the overall pressure and the oxygen (O2) content (i.e., partial pressure of oxygen (pO2)) within the enclosure 12 to create a simulated high-altitude environment having an oxygen (O2) partial pressure of less than 20 kPa, and optionally an overall pressure of less than 97 kPa. As such, the control system 16 may include sensors, gas analyzers, scrubbers (e.g. a carbon dioxide (CO2) scrubber), and other components that allow for monitoring and adjusting the gas composition and pressure within the chamber of the enclosure 12.

In the exemplary embodiments, the control system 16 includes a pump 40 for changing and removing air from the chamber of the enclosure 12, a pressure sensor 42 for determining the air pressure in the chamber, and a controller 44 configured to control the overall pressure within the chamber, based at least in part on a sensed pressure provided by the pressure sensor 42. The control system 16 also includes a gas supply 46 for supplying one or more gases to the enclosure 12. In use, the controller 44 monitors the internal pressure within the chamber using the pressure sensor 42. If the internal pressure greater than a designated value (e.g. greater than 97 kPa), the controller 44 operates the pump 40 to decrease the overall pressure within the enclosure 12 until the designated pressure value is achieved. Alternatively, if the internal pressure is less than a designated value, the controller 44 operates the gas supply 46 to introduce air into the chamber and increase the overall pressure within the enclosure 12 until the designated pressure value is achieved.

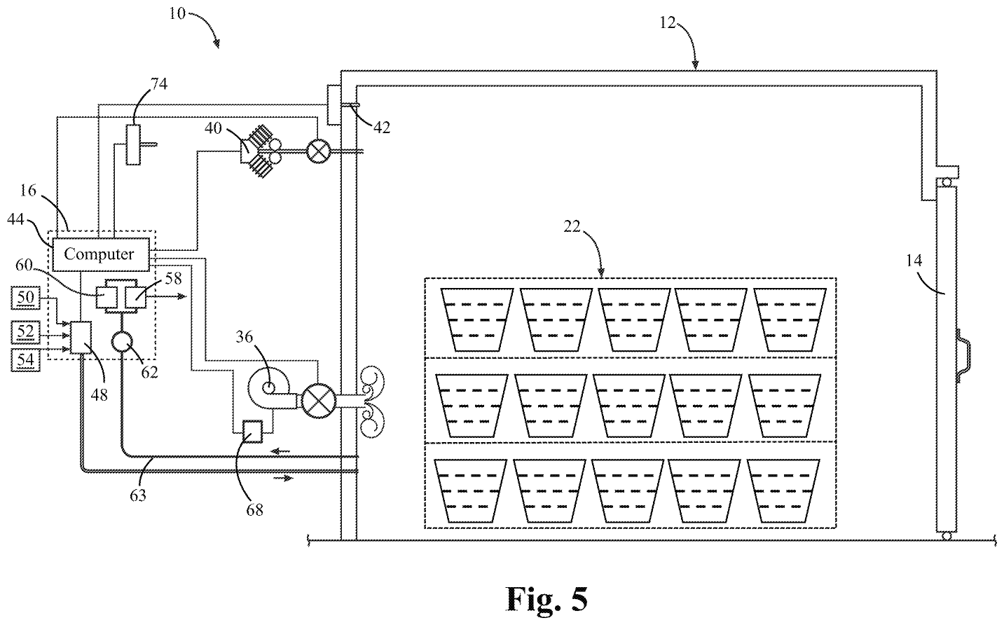

In the illustrated embodiment of FIG. 5, the control system 16 is operatively coupled to a gas manifold 48 for selectively distributing gases to the enclosure 12 from the gas supply 46, which may include one or more sources of nitrogen (N2), oxygen (O2), carbon dioxide (CO2), or other gases (e.g. tanks, generators, etc.), in isolated (i.e., substantially pure/neat) or mixed form. The gas manifold 48 may be a generally conventional manifold, e.g. comprising a plurality of ports and a plurality of two-way solenoids to selectively allow nitrogen (N2), oxygen (O2), and/or carbon dioxide (CO2) to be supplied to the enclosure 12. For example, a nitrogen (N2) source 50, an oxygen (O2) source 52, and a carbon dioxide (CO2) source 54 may be connected to three different ports on the gas manifold 48, and a gas supply line 56 connected to a fourth port. The control system 16 may actuate any or all of the solenoids to connect the nitrogen (N2) source 50, oxygen (O2) source 52, and/or carbon dioxide (CO2) source 54 to the supply line 56, thereby selectively supplying one or more of the gasses to the enclosure 12.

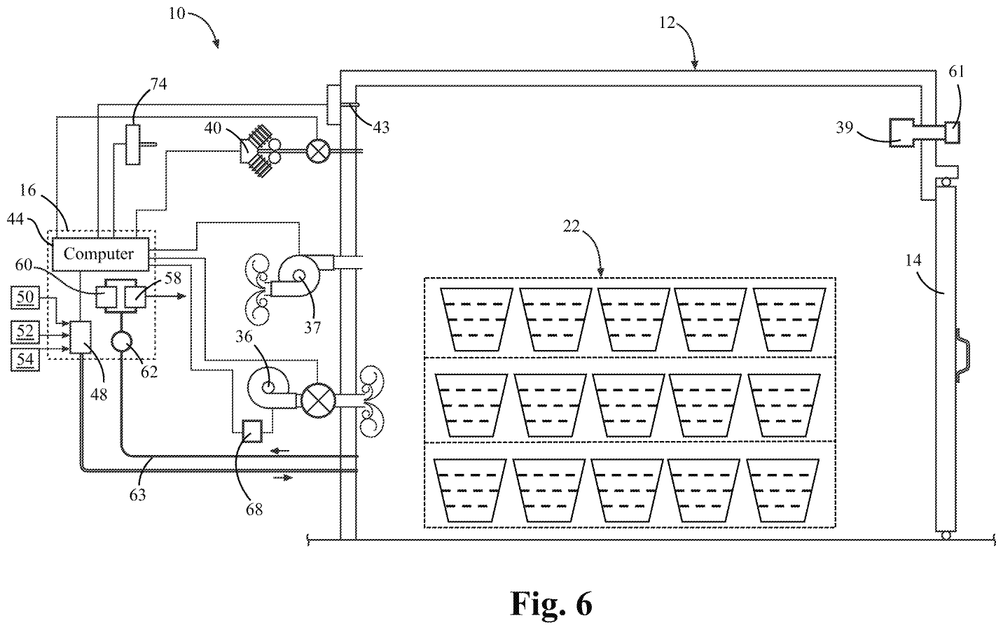

In the embodiment of FIG. 5, the control system 16 includes oxygen (O2) analyzer 58 and carbon dioxide (CO2) analyzer 60, which are operable to determine the oxygen (O2) and carbon dioxide (CO2) content, respectively, of the air in the chamber of the enclosure 12. As the enclosure 12 is typically under reduced pressure, the control system 16 may include a sampling pump 62 for moving a sample of air from within the chamber of the enclosure 12 to the analyzers 58, 60 (e.g. when the analyzers are housed outside of the enclosure 12). For example, a sample line 63 (e.g. poly tubing, copper tubing, etc.) is coupled between the enclosure 12 and the sampling pump 62, which may be actuated by the controller 44 to provide a sample of air from the enclosure 12 to the analyzers 58, 60. While not shown, a return sample line may also be utilized, i.e., when desirable to return sampled air to the enclosure 12. In use, the controller 44 monitors the oxygen (O2) and carbon dioxide (CO2) content of the air in the chamber of the enclosure 12 using the analyzers 58, 60. Alternatively, or additionally, stand-alone oxygen (O2) and/or carbon dioxide (CO2) sensors can be mounted inside chamber 12, e.g. for real-time display of gas content within the chamber 12, as shown generally at 43 in FIG. 6. If the content of one or both gasses is greater than a designated value (e.g. pO2 is greater than 20 kPa), the controller 44 may actuate one or more of the solenoids of the gas manifold 48, e.g. to connect the nitrogen (N2) source 50 to the supply line 56 and thereby supply nitrogen (N₂) gas into to the enclosure 12 to reduce the relative concentration of oxygen (O2) in the air therein.

In the illustrated embodiment of FIG. 6, the control system 16 further includes a blower 37, providing for additional control of the gas composition and pressure within the chamber of the enclosure 12. In particular, the blower 37 is configured to selectively operate (i.e., when activated by the control system 16, e.g. in response to one or more gasses approaching or reaching a designated setpoint) to remove air from the chamber. As such, it will be appreciated that the blower 37 may be implemented in conjunction with the blower 36 and/or pump 40, as a replacement for pump 40, in isolation (i.e., separate from the blower 36, if present), etc. Accordingly, as shown in FIG. 6, the blower 37 may be implemented with a pressure relief system 39, such as the system disclosed in U.S. Pat. No. 10,184,580 to Schaefer et al. The pressure relief system 39 typically includes a relief valve (not shown) for selectively allowing atmospheric air from outside of the enclosure 12 to enter the chamber, and thus may include a filter 61, e.g. to treat, filter, screen, and/or condition the atmospheric air prior to entering the chamber. In use, the controller 44 monitors the partial pressure and/or content of one or more gasses (e.g. oxygen (O2), carbon dioxide (CO2), etc.) within the chamber using the sensor 43, or one or more of the additional sensors/analyzers described above. If the sensed gas content/pressure is greater than, or approaching, a designated value, the controller 44 activates the blower 37 to decrease the overall pressure within the chamber of the enclosure 12, which may be allowed to open the relief valve of the pressure relief system 39 to draw atmospheric air into the chamber and alter the gas composition thereof. In a particular application, the control system 16 may be operated in preparation for a human to enter and/or occupy the chamber of the enclosure 12. In such instance, the blower 37 and pressure relief system 39 may be operated to alter the gas composition within the chamber (e.g. with respect carbon dioxide (CO2) content, oxygen (O2) content, etc.) to levels safe for human respiration and/or exposure.

The control system 16 may also be adapted to adjust various other conditions within the enclosure 12 aside from pressure and gas content, such as temperature, moisture content (e.g. relative humidity), and light exposure, depending on the particular components and systems composing the SHACA room 10. For example, in the exemplary embodiments shown in FIGS. 1-4, the control system 16 includes a temperature sensor 64 and a temperature regulator 65, which are each operatively coupled to the controller 44. In such embodiments, the controller 44 monitors the temperature within the chamber of the enclosure 12 via the temperature sensor 64 and operates the temperature regulator (e.g. implemented as a heater and/or cooler) to establish and maintain a desired temperature within the enclosure 12. The control system 16 also includes a moisture/humidity sensor 66 and an air conditioner 68, which are also operatively coupled to the controller 44. The controller 44 is thus also adapted to measure the moisture content (e.g. relative and/or absolute humidity) within the chamber via the moisture/humidity sensor 66, and to operate the air conditioner 68 (e.g. implemented as a humidifier and/or a dehumidifier) to establish and maintain a desired moisture content within the enclosure 12. The control system 16 also includes one or more lamps 70 (e.g. LED grow lights) and a light sensor 72 each operatively coupled to the controller 44, which may be configured to operate the lamps 70 to provide light to the plants 24 at a particular level and/or over a given period of time. For example, the control system 16 may be adapted to operate the lamps 70 in an on/off cycle (i.e., a light/no-light cycle), to simulate day and night times, respectively. The control system 16 may also be adapted to provide an amount of light to the plants 24 based on a condition of the plants 24, such as a plant maturity phase, growth time, growth start height (e.g. as measured for a seedling plant from the base of the growth media 26 to the top of the plant), seedling stress time, growth maturity height (e.g. as measured for a mature plant from the base of growth media 26 to the top of the plant), etc.

While not shown, the various sensors described above may each independently be implemented as single point-sensors or as a plurality of sensors disposed in different portions around the chamber to monitor conditions throughout the enclosure 12. Moreover, the various sensors described above (i.e., interior/internal sensors for sensing conditions within the enclosure 12) may be paired with one or more external sensors, such as control sensor 74 shown generally in FIG. 5, which are adapted to measure one or more conditions outside of the enclosure 12 (e.g. ambient conditions surrounding the SHACA room 10). For example, while not shown, the SHACA room 10 may include a sampling enclosure adapted to preview the effects of changes in air composition (e.g. oxygen (O2) and/or carbon dioxide (CO2) levels), pressure, temperature, and/or relative humidity with regard to a particular process such as plant growth, drying rate, cure time, etc. An exemplary sampling enclosure 20 can be as described in U.S. Pat. No. 10,143,210 to Schaefer, the disclosure of which is incorporated by reference in its entirety, also available commercially as the SAFEPOD SYSTEM by Storage Control Systems, Inc. of Sparta, Mich. For example, the sampling enclosure may also be coupled to the control system 16. In use, the sampling enclosure 20 is generally maintained in atmospheric communication with the chamber of the enclosure 12, such that the sample lot shares environmental conditions with the chamber. At select times, the sampling enclosure is isolated from the chamber (e.g. via a control valve), and changes in environmental conditions are previewed on the sample lot.

The SHACA room 10 and the control system 16 may be adapted to maintain substantially homogenous conditions throughout the enclosure 12 or, alternatively, to achieve a gradient across portions of the chamber. For example, the control system 16 may be configured to establish a temperature and/or relative humidity gradient between a lower portion of the enclosure 12 (e.g. proximal the plants 24) and the upper portion of the growth chamber (e.g. distal the plants 24), such as when the SHACA room 10 is configured to maintain the plants 24 within a localized optimal temperature and/or relative humidity without particular regard to conditions elsewhere in the enclosure 12. The control system 16 may comprise one or more fans, blowers, circulators, or other devices for homogenizing certain conditions within the enclosure 12, establishing additional gradients therein, or simply to improve airflow within the chamber. For example, in the exemplary embodiments shown in FIGS. 1-4, the vents 34 are disposed proximal the base of the plants 24 allowing for selective control of a localized temperature gradient, as well as for increased air circulation for improved drying, improved lateral plant stress to stimulate stalk fiber growth and reduce wilting, reduced mold/mildew growth, etc.

In the illustrated embodiments described above, the controller 44 of the control system 16 is implemented as a single controller configured to integrate with the various systems and components of the SHACA room 10 (i.e., programmed to control operation of the SHACA room 10, as well as to monitor and adjust for the pressure, gas content, etc. within the enclosure 12 via the control system 16). However, the control functions of the SHACA room 10 and the control system 16 may be implemented using a single controller or a plurality of controllers. For example, control of the SHACA room 10 and the control system 16 may be distributed across a plurality of controllers, which may each operate independently of each other or be coupled for coordinated operation (e.g. by a communication bus or network). The controller 44 may be any microcontroller, or plurality of such controllers, capable of individually or collectively providing the functionality described herein. Particular example of a suitable controller include a SCS integrated controller available from Storage Control Systems, Inc. The controller 44 may be programmed to automatically adjust parameters of the control system 16 (e.g. in response to input data provided by one or more of the sensors) to accommodate changing conditions in the SHACA room 10, the enclosure 12, the facility, and the local climate surrounding the same. Moreover, the controller 44 may be programmed to vary conditions within the chamber of the enclosure 12 based on a growth phase of the plants 24 being utilized.

As introduced above, the preparation method includes exposing a flowering plant to the environment having an oxygen (O2) partial pressure of less than 20 kPa and, optionally, an overall pressure of less than 97 kPa, i.e., an atmosphere having hypoxic and optionally hypobaric conditions similar to that found at high altitudes (e.g. greater than 6,000, alternatively greater than 8,000 feet above sea level). These high-altitude conditions are utilized in the preparation method in combination with one or more environmental conditions, which are not naturally present at high altitudes. As such, the environment utilized in the preparation method (e.g. as established and maintained using the SHACA room 10 described above) may be designated or otherwise described as a simulated high-altitude environment.

In general, the simulated high-altitude environment is a nitrogen (N2) environment, i.e., comprises a predominant amount of nitrogen (N₂) gas in the air. In certain embodiments, the simulated high-altitude environment comprises an overall pressure of from 20 to less than 97 kPa, such as from 20 to 90, alternatively from 20 to 80, alternatively from 20 to 70, alternatively from 20 to 60, alternatively from 20 to 50, alternatively from 30 to 50 kPa. In these or other embodiments, the simulated high-altitude environment comprises an oxygen (O2) partial pressure of from 5 to less than 20 kPa, such as from 5 to 15 kPa, alternatively of from 8 to 14 kPa, alternatively of from 10 to 14 kPa. It will be appreciated that the hypoxic conditions may be alternatively described in terms of oxygen (O2) content in the air, with the simulated high-altitude environment having an oxygen (O2) content of less than 21% (i.e., average ambient atmospheric oxygen (O2) content), alternatively less than 20%, alternatively less than 15%. In certain embodiments, the simulated high-altitude environment has an oxygen (O2) content of from greater than 0 to 20%, such as from 1 to less than 20, alternatively from 2 to less than 20, alternatively from 5 to less than 20, alternatively from 5 to 18, alternatively from 5 to 16, alternatively from 10 to 15%, based on total gas content in the air within the chamber. In these or other embodiments, the simulated high-altitude environment comprises a carbon dioxide (CO2) content of less than 3500 ppm, such as from 600 to 3000, alternatively from 600 to 2000, alternatively from 600 to 1500 ppm. In these or other embodiments, the simulated high-altitude environment comprises a relative humidity of from 40 to 80%, such as from 50 to 80, alternatively from 60 to 80, alternatively from 65 to 75%. In these or other embodiments, the simulated high-altitude environment comprises a temperature of from 10 to 30° C., such as from 12 to 30, alternatively from 12 to 25, alternatively from 15 to 25, alternatively from 15 to 22° C. As described above, the SHACA room 10 is configured to dynamically monitor and control the various conditions in the chamber of the enclosure 12 to establish and maintain the simulated high-altitude environment therein. As such, the values and ranges above may describe target values/set points or average values, and not absolute values during the duration of plant exposure.

The flowering plant may be exposed to the simulated high-altitude environment during any or all phases of cultivation, harvest, and post-harvest processing. For example, the preparation method may comprise exposing the flowering plant to the simulated high-altitude environment in a live immature form (e.g. in the form of a seed, seedling, cutting, etc.), a live mature form, a freshly-harvested form, a post-harvest partially processed form, or any combination thereof. As such, the preparation method may include germinating, growing, harvesting, drying, curing, and/or processing the flowering plant in the simulated high-altitude environment. Likewise, the flowering plant product prepared by the preparation may be a live flowering plant, a harvested flowering plant, or a processed form thereof. In particular embodiments, for example, the preparation method includes extracting one or more components from the flowering plant after the exposure to the simulated high-altitude environment, as described in additional detail below.

The treatment period during which the flowering plant is exposed to the simulated high-altitude environment is not particularly limited, and will be independently selected, for example, based on the type of plant utilized, the growth phase of the plant, a desired growth sequence to be carried out during the exposure, a desired processing step being carried out (e.g. drying, curing, etc.). Typically, the flowering plant is exposed to the simulated high-altitude environment for a treatment period of at least 24, alternatively at least 48, alternatively at least 72 hours. However, longer treatment periods may also be utilized, such as a period of from 5 days to 6 months, alternatively from 1 week to 3 months, alternatively from 10 days to 3 months, alternatively from 2 weeks to 2 months. In certain embodiments, the treatment period includes a growth phase of the plant, alternatively substantially all of a growth phase of the plant, alternatively most of a growth phase of the plant.

In certain embodiments, the simulated high-altitude environment is implemented in two or more sets of conditions, such as a day condition set and a night condition set, which may be alternatingly cycled, i.e., to simulate day and night. For example, the simulated high-altitude environment may include a day period (e.g. a period of light exposure, i.e., exposure to a light condition) of from 6 to 18 hours, such as from 8 to 16, alternatively from 8 to 14, alternatively from 8 to 12, alternatively from 10 to 12 consecutive hours in each 24 hour period, during which time the day condition set is implemented. In the remaining hours in the 24 hour period, the night condition set is implemented, e.g. exposing the plant to a no-light condition). For example, the day conditions may include constant or near constant light exposure and a temperature of from 12 to 30° C., such as from 22 to 24° C., and the night conditions may include no light exposure and a temperature of from 10 to 26° C., such as from 16 to 20° C. Additional condition sets corresponding to particular growth/processing phases of the flowering plant may also be utilized. For example, the relative humidity values above are typically utilized in a growth phase of the flowering plant, whereas a drying and/or curing processing phase will include minimal humidity as water is being removed from the flowering plant.

In particular embodiments, the method includes operating the grow light in an on/off cycle to selectively expose the flowering plant to the light and the no-light condition, respectively, during a single cycle period. The on/off cycle may include any number of cycle periods, such as at least 1, alternatively at least 7, alternatively at least 28, alternatively at least 84, alternatively at least 168 cycle periods, with each including at least one of the light conditions and one of the no-light conditions. In some embodiments, the number of cycle periods is selected based on the flowering plant utilized. For example, the number of cycle periods may be selected to cycle the growth lights for an entire growth phase of the plant. While a cycle period of 24 hours (e.g. to simulate a single day), in certain embodiments a cycle period less than 24 hours may be utilized. For example, the method may include cycling the growth lights on and off over a cycle period of less than 24 hours, such as from 16 to less than 24, alternatively from 16 to 22, alternatively from 18 to 22, alternatively of 20 hours. In such embodiments, the day period may be the same as described above, e.g. from 6 to 18 hours, with the higher end of the range selected only when the cycle period is greater than 18 hours total (i.e., such that a night period may still be included). In particular embodiments, the method includes exposing the flowering plant to the light condition for a consecutive period of from 8 to 14 hours, alternatively from 8 to 12, alternatively from 9 to 12, alternatively from 10 to 12, alternatively from 10 to 11, alternatively of 10 hours, in a cycle period of 20 hours.

The preparation method may be utilized to prepare a flowering plant having an increased content of one or more secondary metabolites compared to a substantially similar flowering plant not exposed to the simulated high-altitude environment. For example, exposing the flowering plant to the simulated high-altitude environment may stimulate, upregulate, or otherwise increase the bioproduction of a secondary metabolite by the flowering plant, or suppress, downregulate, or otherwise decrease the bioproduction of other compounds within the plant to increase the relative proportion of the secondary metabolite. Examples of such secondary metabolites include terpenes and terpenoids, phenolics, glycosides, alkaloids, polyketides, flavonoids, as well as hybrids thereof. For example, in embodiments where a flowering plant the genus Cannabis (i.e., a “Cannabis plant”) is utilized, the preparation method may include increasing the bioproduction of a phytocannabinoid, such as cannabidiol (CBD), tetrahydrocannabinol (THC), cannabinol (CBN), tetrahydrocannabinolic acid (THCA), cannabidiolic acid (CBDA), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabielsoin (CBE), cannabicitran (CBT), or combinations thereof.

As will be appreciated from the description above, depending on the materials, equipment, and parameters employed, the preparation method provides for numerous advantageous over conventional plant growing/cultivation methods, such as increased bioproduction and/or relative concentration of one or more plant secondary metabolites, increased plant vigor, increased/improved crop yield (e.g. by biomass), increased growth rates, improved pest control and/or reduced pesticide requirements, and reduced nutrient requirements. The preparation method may also provide numerous advantageous over conventional processing methods (e.g. post-harvest processing methods), including faster drying times, more efficient/homogenous drying, reduced spoliation, reduced cure times, and even reduced need for cure (e.g. due to increased bioproduction and/or relative concentration of one or more target plant secondary metabolites, decreased production of undesired secondary metabolites, increased oxidation and/or degradation of certain compounds in the plant, etc.). Moreover, the preparation method may be utilized to both cultivate and process (e.g. post-harvesting) a flowering plant to prepare one or more products therefrom, and thus further provides for increased efficiency and decreased labor, energy, and storage needs over conventional pre- and post-harvesting production methods. In certain embodiments, the method prepares a plant at an increased mass as compared to conventional cultivation techniques.

It will be appreciated that particular low-oxygen levels, e.g. for preparing and/or facilitating the simulated high-altitude environment, may be selected based on a natural locations of varying altitudes and oxygen levels. Certain examples of such locations are shown in Table 1 below.

TABLE 1
Oxygen Levels at Altitude

| | | OXYGEN | | |
|---|---|---|---|---|
| ALTITUDE | | LEVEL | BAROMETER | |
| (ft) | (m) | (%) | (inHg) | LOCATIONS AT ELEVATION |
| SEA | SEA | 20.9 | 29.9 | STANDARD/BASE READING |
| LEVEL | LEVEL | | | |
| 1000 | 304 | 20.1 | 28.9 | GROW CONTROL HEADQUARTERS, |
| | | | | SPARTA MI, USA |
| 2000 | 609 | 19.4 | 27.8 | |
| 3000 | 914 | 18.6 | 26.8 | CHAMONIX, FRANCE |
| 4000 | 1219 | 17.9 | 25.8 | SALT LAKE CITY, UTAH |
| 5000 | 1524 | 17.3 | 24.9 | BOULDER, COLORADO |
| 6000 | 1828 | 16.6 | 24 | STANLEY, IDAHO |
| 7000 | 2133 | 16 | 23.1 | FLAGSTAFF, ARIZONA |
| 8000 | 2438 | 15.4 | 22.2 | ASPEN, COLORADO |
| 9000 | 2743 | 14.8 | 21.4 | HUMBOLDT COUNTY, CALIFORNIA |
| 10000 | 3048 | 14.3 | 20.6 | LEADVILLE, COLORADO |
| 11000 | 3352 | 13.7 | 19.8 | CUSCO, PERU |
| 12000 | 3657 | 13.2 | 19 | LA PAZ, BOLIVIA |
| 13000 | 3962 | 12.7 | 18.3 | |
| 14000 | 4267 | 12.3 | 17.6 | PIKES PEAK, COLORADO |
| 15000 | 4572 | 11.8 | 16.9 | MOUNT RAINIER, WASHINGTON |
| 16000 | 4876 | 11.4 | 16.2 | |
| 17000 | 5181 | 11 | 15.6 | MOUNT EVEREST BASE CAMP, |
| | | | | NEPAL |
| 18000 | 5486 | 10.5 | 14.9 | |
| 19000 | 5791 | 10.1 | 14.3 | MOUNT KILIMANJARO, TANZANIA |
| 20000 | 6096 | 9.7 | 13.7 | MOUNT DENALI, ALASKA |
| 21000 | 6400 | 9.4 | 13.1 | |
| 22000 | 6705 | 9 | 12.6 | |
| 23000 | 7010 | 8.7 | 12.1 | ACONCAGUA, ARGENTINA |
| 24000 | 7315 | 8.4 | 11.6 | |
| 25000 | 7620 | 8.1 | 11.1 | HINDU KUSH, PAKISTAN |
| 26000 | 7924 | 7.8 | 10.6 | |
| 27000 | 8229 | 7.5 | 10.1 | CHO OYU, TIBET |
| 28000 | 8534 | 7.2 | 9.5 | K2, PAKISTAN |
| 29000 | 8839 | 6.9 | 8.9 | MOUNT EVEREST, NEPAL |

The following examples are intended to illustrate the invention and are not to be viewed in any way as limiting to the scope of the invention.

### Equipment

A controlled atmosphere room according to the subject invention was utilized in the examples below. Specifically, the controlled atmosphere room was equipped with a mini split refrigeration unit with electric reheat for dehumidification, a mini dehumidifier to assist with dehumidification, a KiloWatch control panel from Grow Controlled LLC, of Sparta Mich., USA, for all-room control (i.e., cooling, dehumidification, lights, atmosphere levels, CO2 injection, water pump, day counter, etc.), a QUAD Sensor (e.g. for determining RH, Temperature, CO2, Lux, etc. in the room), temperature Probe Sensors (6 per room), LED grow lights (2 per room), a drip emitter watering system (0.5 gallon per hour pressure-compensating drip emitters, water pump, RO water filtration), a PSA Nitrogen Generator for low O2 room, and CO2 bottles for increased CO2 in all rooms.

Dairy Doo organic soil, from Morgan Composition, Inc., of Sears Mich., USA, is used in 7-gallon fabric pots as a growth medium. The pots are arranged around the room according to the following plan:

Back Wall

| | |
|---|---|
| Sensor 1 | Sensor 2 |
| Sensor 3 | Sensor 4 |
| Sensor 5 | Sensor 6 |

Door (14)

A CurPod from Grow Controlled LLC, of Sparta Mich., USA, is used for the curing stage.

### Characterization

Samples are analyzed by a laboratory testing vendor service available from, Confident Cannabis, of Palo Alto Calif., USA, via HPLC-PDA, GCMS-MS, and/or LCMS-MS.

### General Procedure 1

Clone: 9-Pound Hammer (9LB) Indica strain clones taken from one mother plant are placed into a Super Sprouter humidity dome, available from Hawthorne Gardening Co. of Vancouver Wash., USA, to grow roots. A fluorescent T5 grow light is utilized in conjunction with a Clone X nutrient solution (Hydrodynamics International, Lansing Mich., USA) to grow roots within 2 weeks.

Vegetative Stage: After 2 weeks in the humidity dome, the root cubes are placed into a 1-gallon pot of Dairy Doo organic soil to grow into bigger plants. LED lights are timed using a KiloWatch control system to create 18 hours on/6 hours off light cycle. As the plants grow, 9LB plants were up-potted again into 7-gallon fabric pots. The vegetative stage lasts 4 weeks.

Flowering Stage: After the plants grow to a desirable size, the light cycle is changed to 12 hours on/12 hours off to induce flower and/or bud production. As the use of the organic soil makes the plant less dependent on constant nutrient feed, drip feed was used to water the plants, and a flower boost is fed to each plant weekly. The flowering stage lasts ˜60 days.

Harvest: After flowering until maturity, each plant is harvested via being chopped from the base and hung upside down to dry. Maturity is determined by evaluating trichome production on the buds. After most of the trichomes are milky and at least 50% amber in color (e.g. via visual inspection), the plants are concluded to be finished/mature. After a plant is harvested, it begins to release CO2. Wet whole-plant mass is recorded at this stage.

Dry: Each plant is hung in a dry room to dry for 7 days with venting to remove CO2 production from the harvested plants during drying. After the 7 days, the buds are ready to be trimmed. Dry whole-plant mass is recorded at this stage.

Trim: Each bud cluster is cut and trimmed from the whole plant and placed into a labeled plastic bin. Dry trimmed bud weight is recorded at this stage.

Cure: Each bin of trimmed buds is placed and kept in a dark, humidity-controlled chamber to allow for further off-gassing (e.g. CO2 release) and cure.

### Example 1 and Comparative Example 1

Two growth cycles are performed using the controlled atmosphere room, according to General Procedure 1 as outlined above, to give plant products of Example 1 and Comparative Example 1. More specifically, Comparative Example 1 is carried out using ambient oxygen levels (i.e., ˜21% O2) during the flowering stage of the plant, and Example 1 is carried out at the same stage of plant cultivation but with decreased O2 levels (e.g. i.e., <21% O2, via displacement of oxygen from the room). The particular set points for each room are provided below in Tables 2 and 3.

TABLE 2
Set Points of Comparative Example 1

| | | Temp. | RH | O2 | Simulated | CO2 | Photoperiod |
|---|---|---|---|---|---|---|---|
| Week(s) | Stage | (F.) | (%) | (%) | Altitude (ft) | (ppm) | (hr/hr) |
| 1-4 | Vegetative | 80 | 63 | 21 | Sea Level | 800 | 18/6 |
| 5-7 | Flowering | 80 | 63 | 21 | Sea Level | 1000 | 12/12 |
| 8 | Flowering | 78 | 60 | 21 | Sea Level | 1200 | 12/12 |
| 9-10 | Flowering | 78 | 57 | 21 | Sea Level | 1200 | 12/12 |
| 11 | Flowering | 76 | 54 | 21 | Sea Level | 1200 | 12/12 |
| 12 | Flowering | 70 | 54 | 21 | Sea Level | 1200 | 12/12 |
| 13 | Flowering | 67 | 52 | 21 | Sea Level | 1200 | 12/12 |
| 14 | Flowering | 64 | 51 | 21 | Sea Level | 1200 | 12/12 |

TABLE 3
Set Points of Example 1

| | | Temp. | RH | O2 | Simulated | CO2 | Photoperiod |
|---|---|---|---|---|---|---|---|
| Week(s) | Stage | (F.) | (%) | (%) | Altitude (ft) | (ppm) | (hr/hr) |
| 1-4 | Vegetative | 80 | 63 | 21 | Sea Level | 800 | 18/6 |
| 5-7 | Flowering | 80 | 63 | 14 | 10000 | 1000 | 12/12 |
| 8 | Flowering | 78 | 60 | 14 | 10000 | 1200 | 12/12 |
| 9-10 | Flowering | 78 | 57 | 14 | 10000 | 1200 | 12/12 |
| 11 | Flowering | 76 | 54 | 14 | 10000 | 1200 | 12/12 |
| 12 | Flowering | 70 | 54 | 14 | 10000 | 1200 | 12/12 |
| 13 | Flowering | 67 | 52 | 14 | 10000 | 1200 | 12/12 |
| 14 | Flowering | 64 | 51 | 14 | 10000 | 1200 | 12/12 |

The plants are disposed in preselected locations around the room in accordance with the plan further above. The location of each of the plants is recorded and maintained after harvest. The weights of the plant mass recorded during post-flowering steps is shown in Tables 5 and 6 below, along with the weights collected during cultivation process

TABLE 4
Plant Properties of Comparative Example 1

| | | Wet | Dry | Trimmed |
|---|---|---|---|---|
| Tag | Genetic | Weight (lb) | Weight (lb) | Weight (g) |
| 1-1A | 9 lb Hammer | 1.00 | 0.30 | 64.00 |
| 1-2A | 9 lb Hammer | 1.00 | 0.50 | 71.00 |
| 1-3A | 9 lb Hammer | 1.20 | 0.30 | 72.00 |
| 1-4A | 9 lb Hammer | 1.30 | 0.30 | 74.00 |
| 1-5A | 9 lb Hammer | 1.00 | 0.20 | 58.00 |
| 1-6A | 9 lb Hammer | 1.20 | 0.30 | 76.00 |

| | | | |
|---|---|---|---|
| Total: | 6.70 | 1.90 | 415.00 |

TABLE 5
Plant Properties of Example 1

| | | Wet | Dry | Trimmed |
|---|---|---|---|---|
| Tag | Genetic | Weight (lb) | Weight (lb) | Weight (g) |
| 1-1B | 9 lb Hammer | 1.10 | 0.50 | 67.00 |
| 1-2B | 9 lb Hammer | 1.10 | 0.40 | 72.00 |
| 1-3B | 9 lb Hammer | 1.20 | 0.30 | 61.00 |
| 1-4B | 9 lb Hammer | 1.10 | 0.40 | 88.00 |
| 1-5B | 9 lb Hammer | 1.10 | 0.30 | 62.00 |
| 1-6B | 9 lb Hammer | 1.20 | 0.30 | 95.00 |

| | | | |
|---|---|---|---|
| Total: | 6.70 | 2.20 | 445.00 |

As shown in the tables above, preparing the plant product according to the present method results a higher yield of the product. Specifically, the plant product prepared according to the inventive method demonstrated in Example 1 comprises a final mass 7.23% larger than that of Comparative Example 1, showing the preparation method may be used to prepare the plant product in higher yields (e.g. by biomass) over methods absent the simulated environment described herein.

The plant products are evaluated via the characterization set forth further above, e.g. to determine the cannabinoid and terpene contents thereof. The results of this evaluation for Example 1 and Comparative Example 1 are set forth in Tables 6-8 below.

TABLE 6
Cannabinoid Content of Plant Product

| | | Comparative Ex. 1 | | Example 1 | |
|---|---|---|---|---|---|
| | LOQ | | Mass | | Mass |
| Analyte | (%) | Mass (%) | (mg/g) | Mass (%) | (mg/g) |
| THCa: | 0.0001 | 13.8878 | 138.878 | 17.2147 | 172.147 |
| Δ9-THC: | 0.0001 | 0.7102 | 7.102 | 0.4055 | 4.055 |
| Δ8-THC: | 0.0001 | <LOQ | <LOQ | <LOQ | <LOQ |
| CBD: | 0.0001 | <LOQ | <LOQ | <LOQ | <LOQ |
| CBDa: | 0.0001 | <LOQ | <LOQ | <LOQ | <LOQ |
| CBG: | 0.0001 | 0.0545 | 0.545 | <LOQ | <LOQ |
| CBN: | 0.0001 | <LOQ | <LOQ | <LOQ | <LOQ |
| THCV: | 0.0001 | <LOQ | <LOQ | <LOQ | <LOQ |
| CBGa: | 0.0001 | 0.3563 | 3.563 | 0.3617 | 3.617 |

| | | | | |
|---|---|---|---|---|
| Total THC: | 12.8898 | 128.898 | 15.5028 | 155.028 |
| Total CBD: | <LOQ | <LOQ | <LOQ | <LOQ |
| Total: | 15.0088 | 150.088 | 17.9819 | 17.9819 |

“LOQ” is the Limit of Quantitation. The reported data is based on a sample weight with an applicable sample-specific moisture content. Similarly, where used herein, “ND” is an indication of nondetection.

TABLE 7
Terpene Content of Plant Product

| | | Comparative | | | |
|---|---|---|---|---|---|
| | | Example 1 | | Example 1 | |
| | LOQ | Mass | Mass | Mass | Mass |
| Analyte | (mg/g) | (mg/g) | (%) | (mg/g) | (%) |
| α-Pinene | 0.001 | 5.500 | 0.5500 | 6.018 | 0.6018 |
| β-Myrcene | 0.001 | 4.232 | 0.4232 | 3.746 | 0.3746 |
| β-Pinene | 0.001 | 2.648 | 0.2648 | 2.877 | 0.2877 |
| d-Limonene | 0.001 | 1.649 | 0.1649 | 1.551 | 0.1551 |
| β-Caryophyllene | 0.001 | 0.928 | 0.0928 | 1.028 | 0.1028 |
| Linalool | 0.001 | 0.877 | 0.0877 | 1.076 | 0.1076 |
| β-Ocimene | 0.001 | 0.438 | 0.0438 | 0.479 | 0.0479 |
| Terpinolene | 0.001 | 0.230 | 0.0230 | 0.236 | 0.0236 |
| α-Humulene | 0.001 | 0.199 | 0.0199 | 0.222 | 0.0222 |
| Camphene | 0.001 | 0.141 | 0.0141 | 0.163 | 0.0163 |
| Trans-Nerolidol | 0.001 | 0.039 | 0.0039 | 0.037 | 0.0037 |
| α-Bisabolol | 0.001 | 0.020 | 0.0020 | 0.022 | 0.0022 |
| Isopulegol | 0.001 | 0.020 | 0.0020 | 0.013 | 0.0013 |
| Eucalyptol | 0.001 | 0.009 | 0.0009 | 0.012 | 0.0012 |
| γ-Terpinene | 0.001 | 0.005 | 0.0005 | 0.009 | 0.0009 |
| Caryophyllene Oxide | 0.001 | 0.003 | 0.0003 | 0.004 | 0.0004 |
| Guaiol | 0.001 | 0.002 | 0.0002 | ND | ND |
| 3-Carene | 0.001 | ND | ND | 0.006 | 0.0006 |
| α-Terpinene | 0.001 | ND | ND | 0.006 | 0.0006 |
| Geraniol | 0.001 | ND | ND | ND | ND |
| Nerolidol | 0.001 | ND | ND | ND | ND |
| Ocimene | 0.001 | ND | ND | 0.245 | 0.0245 |
| p-Cymene | 0.001 | ND | ND | ND | ND |

TABLE 8
Top Terpene Content of Plant Products

| | Comparative | | |
|---|---|---|---|
| | Example 1 | Example 1 | |
| Analyte | Mass (mg/g) | Mass (mg/g) | % Change |
| α-Pinene | 5.500 | 6.018 | 9.42 |
| β-Myrcene | 4.232 | 3.746 | −12.72 |
| β-Pinene | 2.648 | 2.877 | 9.03 |
| d-Limonene | 1.649 | 1.551 | −5.94 |
| β-Caryophyllene | 0.928 | 1.028 | 10.78 |
| Linalool | 0.877 | 1.076 | 22.69 |
| β-Ocimene | 0.438 | 0.479 | 9.36 |
| Terpinolene | 0.230 | 0.236 | 2.61 |
| α-Humulene | 0.199 | 0.222 | 11.56 |
| Camphene | 0.141 | 0.163 | 15.6 |
| Total: | 16.84 | 17.4 | 3.33 |

As shown in the tables above, preparing the plant product according to the present method results in an increased production of certain secondary metabolites in the plant. Specifically, as shown in Table 6 above, preparing the plant product in the simulated high-altitude environment can provide a plant product with a 20% increase in THC content over the comparative example. Similarly, as shown in Tables 7 and 8, the simulated high-altitude environment utilized in preparing the plant product of Example 1 also stimulates an increase in terpene production, both in terms of overall terpene content as well as individual terpene proportions, over the comparative example.

### General Procedure 2

Clone: 9-Pound Hammer (9LB) strain clones taken from one mother plant are placed into an EZ-Clone, available from EZ-CLONE Enterprises Inc. of Sacramento Calif., USA, to grow roots. An LED grow light is utilized in conjunction with a Clone X nutrient solution, available from Hydrodynamics International of Lansing Mich., USA, to grow roots within 2 weeks.

Vegetative Stage: After 2 weeks in the EZ-Clone, the root cubes are placed into a 1-gallon pot of coco base nutrient to grow into bigger plants. LED lights are timed using a KiloWatch control system to create 18 hours on/6 hours off light cycle. As the plants grow, 9LB plants were up-potted again into 7-gallon fabric pots. The vegetative stage lasts 4 weeks.

Flowering Stage: After the plants grew to a desirable size, the light cycle is changed to 12 hours on/12 hours off to induce flower and/or buds production as described above. As the use the Pro-Mix soil increased nutrient dependency, the plants are hand watered each day with a 3-part flowering nutrient solution. The flower stage lasts 75 days. Use of CO2 bottles for increased CO2 in each room.

Harvest: After flowering until maturity (determined as described above), each plant is harvested by being chopped from the base and hung upside down to dry and begin off-gassing (e.g. releasing CO2). Wet whole-plant mass is recorded at this stage.

Dry: Each plant is hung in a dry room to dry for 7 days with venting to remove CO2 production from the harvested plants during drying. After the 7 days, the buds are ready to be trimmed.

Trim: Each bud cluster is cut and trimmed from the whole plant and placed into a labeled plastic bin. Dry trimmed bud weight is recorded at this stage.

Cure: Each bin of trimmed buds is placed and kept in a CurPod to allow for further off-gassing (e.g. CO2 release) and cure.

### Example 2 and Comparative Example 2

Two growth cycles are performed using the controlled atmosphere room, according to General Procedure 2 as outlined above, to give plant products of Example 2 and Comparative Example 2. More specifically, Comparative Example 2 is carried out using ambient oxygen levels (i.e., ˜21% O2) during the flowering stage of the plant, and Example 2 is carried out at the same stage of plant cultivation but with decreased O2 levels (e.g. i.e., <21% O2, via displacement of oxygen from the room). The particular set points for each room are provided below in Tables 9 and 10 below.

TABLE 9
Set Points of Comparative Example 2

| | | Temp. | RH | O2 | Simulated | CO2 | Photoperiod |
|---|---|---|---|---|---|---|---|
| Week(s) | Stage | (F.) | (%) | (%) | Altitude (ft) | (ppm) | (hr/hr) |
| 1-4 | Vegetative | 80 | 63 | 21 | Sea Level | 800 | 18/6 |
| 5-7 | Flowering | 80 | 63 | 21 | Sea Level | 1000 | 12/12 |
| 8 | Flowering | 78 | 60 | 21 | Sea Level | 1200 | 12/12 |
| 9-10 | Flowering | 78 | 57 | 21 | Sea Level | 1200 | 12/12 |
| 11 | Flowering | 76 | 54 | 21 | Sea Level | 1200 | 12/12 |
| 12 | Flowering | 70 | 54 | 21 | Sea Level | 1200 | 12/12 |
| 13 | Flowering | 67 | 52 | 21 | Sea Level | 1200 | 12/12 |
| 14 | Flowering | 64 | 51 | 21 | Sea Level | 1200 | 12/12 |

TABLE 10
Set Points of Example 2

| | | Temp. | RH | O2 | Simulated | CO2 | Photoperiod |
|---|---|---|---|---|---|---|---|
| Week(s) | Stage | (F.) | (%) | (%) | Altitude (ft) | (ppm) | (hr/hr) |
| 1-4 | Vegetative | 80 | 63 | 21 | Sea Level | 800 | 18/6 |
| 5-7 | Flowering | 80 | 63 | 14 | 10,000 | 1000 | 12/12 |
| 8 | Flowering | 78 | 60 | 14 | 10,000 | 1200 | 12/12 |
| 9-10 | Flowering | 78 | 57 | 14 | 10,000 | 1200 | 12/12 |
| 11 | Flowering | 76 | 54 | 14 | 10,000 | 1200 | 12/12 |
| 12 | Flowering | 70 | 54 | 14 | 10,000 | 1200 | 12/12 |
| 13 | Flowering | 67 | 52 | 14 | 10,000 | 1200 | 12/12 |
| 14 | Flowering | 64 | 51 | 14 | 10,000 | 1200 | 12/12 |

The plants are disposed in preselected locations around the room in accordance with the plan further above. The location of each of the plants is recorded and maintained after harvest. The weights of the plant mass recorded during post-flowering steps is shown in tables 11 and 12 below, along with the weights collected during cultivation process.

TABLE 11
Plant Properties of Comparative Example 2

| | | Wet | Trim | Bud |
|---|---|---|---|---|
| Tag | Genetic | Weight (kg) | Weight (g) | Weight (g) |
| 2-1A | 9 lb Hammer | 2.010 | 33 | 315 |
| 2-2A | 9 lb Hammer | 1.560 | 30 | 204 |
| 2-3A | 9 lb Hammer | 1.265 | 43 | 162 |
| 2-4A | 9 lb Hammer | 1.430 | 29 | 192 |
| 2-5A | 9 lb Hammer | 1.410 | 27 | 168 |
| 2-6A | 9 lb Hammer | 1.030 | 28 | 117 |

| | | | |
|---|---|---|---|
| Total: | 8.705 | 190 | 1158 |

TABLE 12
Plant Properties of Example 2

| | | Wet | Trim | Bud |
|---|---|---|---|---|
| Tag | Genetic | Weight (kg) | Weight (g) | Weight (g) |
| 2-1B | 9 lb Hammer | 1.820 | 34 | 269 |
| 2-2B | 9 lb Hammer | 1.670 | 28 | 232 |
| 2-3B | 9 lb Hammer | 1.670 | 16 | 245 |
| 2-4B | 9 lb Hammer | 1.500 | 29 | 188 |
| 2-5B | 9 lb Hammer | 1.750 | 33 | 229 |
| 2-6B | 9 lb Hammer | 1.580 | 34 | 208 |

| | | | |
|---|---|---|---|
| Total: | 8.705 | 174 | 1371 |

As shown in the tables above, preparing the plant product according to the present method results a higher yield of the product. Specifically, the plant product prepared according to the inventive method demonstrated in Example 2 comprises a final mass 18.39% larger than that of Comparative Example 2.

The plant products are evaluated via the characterization set forth further above, e.g. to determine the cannabinoid and terpene contents thereof. The results of this evaluation for Example 2 and Comparative Example 2 are set forth in Tables 13 and 14 below.

TABLE 13
Cannabinoid Content of Plant Product

| | | Comparative Ex. 2 | | Example 2 | |
|---|---|---|---|---|---|
| | LOQ | Mass | Mass | Mass | Mass |
| Analyte | (%) | (%) | (mg/g) | (%) | (mg/g) |
| THCa: | 0.0001 | 25.3170 | 253.170 | 25.1188 | 251.188 |
| Δ9-THC: | 0.0001 | 0.2597 | 2.597 | 0.2597 | 7.102 |
| Δ8-THC: | 0.0001 | <LOQ | <LOQ | <LOQ | <LOQ |
| CBD: | 0.0001 | <LOQ | <LOQ | <LOQ | <LOQ |
| CBDa: | 0.0001 | 0.0332 | 0.332 | <LOQ | <LOQ |
| CBG: | 0.0001 | <LOQ | <LOQ | <LOQ | <LOQ |
| CBN: | 0.0001 | <LOQ | <LOQ | <LOQ | <LOQ |
| THCV: | 0.0001 | <LOQ | <LOQ | <LOQ | <LOQ |
| CBGa: | 0.0001 | 0.4728 | 4.728 | 0.3356 | 3.563 |

| | | | | |
|---|---|---|---|---|
| Total THC: | 22.4627 | 22.4627 | 22.0292 | 128.898 |
| Total CBD: | 0.0291 | 0.0291 | <LOQ | <LOQ |
| Total: | 26.0827 | 26.0827 | 25.4545 | 254.545 |

TABLE 14
Terpene Content of Plant Product

| | | Comparative | | | |
|---|---|---|---|---|---|
| | | Example 2 | | Example 2 | |
| | LOQ | Mass | Mass | Mass | Mass |
| Analyte | (mg/g) | (mg/g) | (%) | (mg/g) | (%) |
| α-Pinene | 0.001 | 4.230 | 0.4230 | 6.951 | 0.6951 |
| β-Myrcene | 0,001 | 5.076 | 0.5076 | 6.057 | 0.6057 |
| β-Pinene | 0.001 | 1.994 | 0.1994 | 3.027 | 0.3027 |
| d-Limonene | 0.001 | 1.659 | 0.1659 | 2.082 | 0.2082 |
| β-Caryophyllene | 0.001 | 0.699 | 0.0699 | 1.257 | 0.1257 |
| Linalool | 0.001 | 0.987 | 0.0987 | 1.127 | 0.1127 |
| β-Ocimene | 0.001 | 0.095 | 0.0095 | 0.156 | 0.0156 |
| Terpinolene | 0.001 | <LOQ | <LOQ | <LOQ | <LOQ |
| α-Humulene | 0.001 | <LOQ | <LOQ | <LOQ | <LOQ |
| Camphene | 0.001 | 0.142 | 0.0142 | 0.171 | 0.0171 |
| trans-Nerolidol | 0.001 | 0.032 | 0.0032 | 0.034 | 0.0034 |
| α-Bisabolol | 0.001 | 0.027 | 0.0027 | 0.036 | 0.0036 |
| Isopulegol | 0.001 | 0.022 | 0.0022 | 0.019 | 0.0019 |
| Eucalyptol | 0.001 | 0.008 | 0.0008 | 0.010 | 0.0010 |
| γ-Terpinene | 0.001 | 0.005 | 0.0005 | 0.007 | 0.0007 |
| Caryophyllene Oxide | 0.001 | 0.005 | 0.0005 | 0.008 | 0.0008 |
| Guaiol | 0.001 | <LOQ | <LOQ | <LOQ | <LOQ |
| 3-Carene | 0.001 | 0.005 | 0.005 | <LOQ | <LOQ |
| α-Terpinene | 0.001 | <LOQ | <LOQ | <LOQ | <LOQ |
| Geraniol | 0.001 | <LOQ | <LOQ | <LOQ | <LOQ |
| Nerolidol | 0.001 | <LOQ | <LOQ | <LOQ | <LOQ |
| Ocimene | 0.001 | <LOQ | <LOQ | <LOQ | <LOQ |
| p-Cymene | 0.001 | <LOQ | <LOQ | <LOQ | <LOQ |

As shown in the tables above, preparing the plant product according to the present method may result in an increased production of secondary metabolites in the plant. Specifically, as shown in Tables 13 and 14, the simulated high-altitude environment utilized in preparing the plant product of Example 2 also stimulates an increase in terpene production, both in terms of overall terpene content as well as individual terpene proportions, over the comparative example. The inventive method utilized in Example 2, for instance, prepared the plant product with 39.79% more terpenes by total weight (5.961 mg/g).

The plan products of Example 2 and Comparative Example 2 were evaluated via lab test for pesticides, microbials, mycotoxins, heavy metals, and foreign matter. The results of these analysis are shown in Table 15 below.

TABLE 15
Pesticides Content of Plant Products

| | | | Comparative | |
|---|---|---|---|---|
| | LOQ | Limit | Example 2 | Example 2 |
| Analyte | (PPM) | (PPM) | Mass (PPM) | Mass (PPM) |
| Abamectin | 0.005 | 0.002 | <LOQ | <LOQ |
| Acequinocyl | 0.002 | 4.000 | <LOQ | <LOQ |
| Bifenazate | 0.002 | 0.400 | <LOQ | <LOQ |
| Bifenthrin | 0.005 | 0.100 | <LOQ | <LOQ |
| Cyfluthrin | 0.005 | 2.000 | <LOQ | <LOQ |
| Cypermethrin | 0.005 | 1.000 | <LOQ | <LOQ |
| Daminozide | 0.005 | 0.800 | <LOQ | <LOQ |
| Dimethomorph | 0.002 | 2.000 | <LOQ | <LOQ |
| Etoxazole | 0.002 | 0.400 | <LOQ | <LOQ |
| Fenhexamid | 0.005 | 1.000 | <LOQ | <LOQ |
| Flonicamid | 0.005 | 1.000 | <LOQ | <LOQ |
| Fludioxonil | 0.002 | 0.500 | <LOQ | <LOQ |
| Imidacloprid | 0.002 | 0.500 | <LOQ | <LOQ |
| Myclobutanil | 0.002 | 0.400 | <LOQ | <LOQ |
| Paclobutrazol | 0.005 | 0.400 | <LOQ | <LOQ |
| Piperonyl Butoxide | 0.002 | 3.000 | <LOQ | <LOQ |
| Pyrethrins | 0.010 | 0.112 | <LOQ | <LOQ |
| Quintozene | 0.005 | 0.800 | <LOQ | <LOQ |
| Spinetoram | 0.002 | 1.000 | <LOQ | <LOQ |
| Spinosad | 0.002 | 1.000 | <LOQ | <LOQ |
| Spirotetramat | 0.002 | 1.000 | <LOQ | <LOQ |
| Thiamethoxam | 0.002 | 0.4 | <LOQ | <LOQ |
| Trifloxystrobin | 0.002 | 1000 | <LOQ | <LOQ |

TABLE 16
Heavy Metal and Mycotoxins Content of Plant Products

| | | | Comparative | |
|---|---|---|---|---|
| | LOQ | Limit | Example 2 | Example 2 |
| Analyte | (PPB) | (PPB) | Mass (PPB) | Mass (PPB) |
| Arsenic | 2.0 | 2000.0 | <LOQ | <LOQ |
| Cadmium | 2.0 | 820.0 | <LOQ | <LOQ |
| Lead | 2.0 | 1200.0 | <LOQ | <LOQ |
| Mercury | 2.0 | 400.0 | <LOQ | <LOQ |
| Aflatoxins | 2.0 | 20.00 | 2.40 | 3.40 |
| Ochratoxin A | 2.0 | 20.00 | 10.30 | 12.70 |

TABLE 17
Microbial Content of Plant Products

| | | | Comparative | |
|---|---|---|---|---|
| | | | Example 2 | Example 2 |
| | LOQ | Limit | Units | Units |
| Analyte | (CFU/g) | (CFU/g) | (CFU/g) | (CFU/g) |
| Aspergillus flavus | 1 | 1 | ND | ND |
| Aspergillus fumigatus | 1 | 1 | ND | ND |
| Aspergillus niger | 1 | 1 | ND | ND |
| Aspergillus terreus | 1 | 1 | ND | ND |
| Bile-Tolerant Gram- | 100 | 1000 | <LOQ | <LOQ |
| Negative Bacteria | | | | |
| Coliforms | 100 | 1000 | <LOQ | <LOQ |
| E. Coli | — | 1 | ND | ND |
| Salmonella | — | 1 | ND | ND |
| Yeast & Mold | 1000 | 10000 | 2000 | 2000 |

The above description relates to general and specific embodiments of the disclosure. However, various alterations and changes can be made without departing from the spirit and broader aspects of the disclosure as defined in the appended claims, which are to be interpreted in accordance with the principles of patent law including the doctrine of equivalents. As such, this disclosure is presented for illustrative purposes and should not be interpreted as an exhaustive description of all embodiments of the disclosure or to limit the scope of the claims to the specific elements illustrated or described in connection with these embodiments. Any reference to elements in the singular, for example, using the articles “a,” “an,” “the,” or “said,” is not to be construed as limiting the element to the singular. Further, it is to be understood that the terms “right angle”, “orthogonal”, and “parallel” are generally employed herein in a relative and not an absolute sense.

Likewise, it is also to be understood that the appended claims are not limited to express and particular compounds, compositions, or methods described in the detailed description, which may vary between particular embodiments that fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A method of preparing a flowering plant product, said method comprising:
providing a controlled atmosphere room including a chamber and a microclimate control system, the microclimate control system operable to establish and maintain within the chamber a simulated high-altitude environment having an oxygen (O2) partial pressure of 5 to 15 kPa;
disposing a flowering plant on a plant support structure disposed within the chamber, wherein the flowing plant is a plant in the genus of Cannabis; and
exposing the flowering plant to the simulated high-altitude environment within the chamber via the microclimate control system for a treatment period of 5 days to 6 months.

2. The method of claim 1, further comprising: (i) germinating the flowering plant in the simulated high-altitude environment within the chamber; (ii) growing the flowering plant in the simulated high-altitude environment within the chamber; (iii) drying the flowering plant in the simulated high-altitude environment within the chamber; (iv) curing the flowering plant in the simulated high-altitude environment within the chamber; or (v) any combination of (i)-(iv).

3. The method of claim 1, wherein the flowering plant is exposed to the simulated high-altitude environment for the entire growth period of the plant.

4. The method of claim 1, wherein exposing the flowering plant to the simulated high-altitude environment increases: (i) the bioproduction of a secondary metabolite by the flowering plant; (ii) the growth of the flowering plant, by mass; or (iii) both (i) and (ii), as compared to a substantially similar flowering plant not exposed to the simulated high-altitude environment.

5. The method of claim 4, wherein the secondary metabolite is a phytocannabinoid.

6. The method of claim 4, wherein the secondary metabolite is cannabidiol (CBD), tetrahydrocannabinol (THC), or cannabinol (CBN).

7. The method of claim 1, wherein the microclimate control system comprises a pump for changing and removing air from the chamber, a pressure sensor for determining air pressure in the chamber, and a controller operatively coupled to the pump and the pressure sensor, the controller configured to establish and maintain within the chamber an overall pressure of less than 30 kPa based at least in part on a sensed pressure provided by the pressure sensor.

8. (canceled)

9. The method of claim 7, wherein the microclimate control system further comprises a gas supply system for selectively supplying one or more gasses to the chamber and a gas sensor for determining a content of at least one gas in the chamber, wherein the gas supply system and the gas sensor are operatively coupled to the controller, and wherein the controller is configured to establish and maintain within the chamber a nitrogen (N2) environment having an oxygen (O2) partial pressure of from 5 to 15 20 kPa based at least in part on a sensed oxygen (O2) content provided by the gas sensor.

10. The method of claim 9, wherein the gas supply system comprises: (i) a nitrogen (N2) source; (ii) an oxygen (O2) source; (iii) a carbon dioxide (CO2) source; (iv) a water (H2O) source; or (v) any combination of (i)-(iv).

11. (canceled)

12. The method of claim 9, wherein the controller is configured to establish and maintain within the chamber a carbon dioxide (CO2) content of from 600 to 3000 ppm.

13. The method of claim 9, wherein the controller is configured to establish and maintain within the chamber a relative humidity of from 40 to 80%.

14. The method of claim 7, wherein the microclimate control system is configured to dynamically control relative humidity within the chamber.

15. The method of claim 7, wherein the microclimate control system further comprises a moisture sensor for determining the moisture content of the flowering plant, wherein the moisture sensor is operatively coupled to the controller, and wherein the controller controls an amount and a rate at which water is removed from the flowering plant.

16. The method of claim 7, wherein the microclimate control system further comprises a temperature sensor for determining temperature in the chamber and a temperature regulator operable to selectively heat and cool the chamber, wherein the temperature sensor and the temperature regulator are operatively coupled to the controller, and wherein the controller is configured to establish and maintain within the chamber a temperature of from 10 to 30° C.

17. The method of claim 7, wherein the microclimate control system further comprises a grow light for providing light to the flowering plant in the chamber, wherein the grow light is operatively coupled to the controller, and wherein the controller is configured to operate the grow light in an on/off cycle to selectively expose the flowering plant to a light and a no-light condition, respectively.

18. The method of claim 17, wherein the on/off cycle comprises at least 7, optionally at least 28, optionally at least 84, optionally at least 168 cycle periods, each including at least one of the light conditions and one of the no-light conditions, and wherein: (i) the controller is configured to operate the grow light to provide a light condition of from 8 to 14 hours in a consecutive 24 hour cycle period; (ii) the controller is configured to operate the grow light to provide a light condition of from 8 to 12 hours in a consecutive 20 hour cycle period; or (iii) any combination of (i) and (ii).

19. The method of claim 1, wherein the controlled atmosphere room further comprises a nutrient management system in fluid communication with the plant support structure for delivering water and nutrients to the flowering plant.

20. The method of claim 1, wherein conditions of the simulated high-altitude environment are independently selected depending on growth and/or processing phase of the flowering plant.

21. A simulated high-altitude controlled atmosphere room for cultivating and processing flowering plants in the genus of Cannabis, comprising:
a gastight enclosure defining a chamber;
a plant support structure disposed within the chamber for supporting a flowering plant;
a pump for changing and removing air from the chamber;
a gas supply for selectively supplying nitrogen (N2), oxygen (O2), and carbon dioxide (CO2) to the chamber; and
an active microclimate control operatively coupled to the pump and the gas supply, the active microclimate control including at least one sensor operable to sense microclimate conditions including the pressure, oxygen (O2) content, and carbon dioxide (CO2) content within the chamber, and a controller configured to establish and maintain within the chamber a nitrogen (N2) environment having an oxygen (O2) partial pressure of 5 to 15 kPa based at least in part on one or more sensed microclimate conditions provided by the at least one sensor.

22. The simulated high-altitude controlled atmosphere room of claim 21, wherein the active microclimate control is configured to establish and maintain within the chamber an overall pressure of 30 to 50 kPa based at least in part on one or more sensed microclimate conditions provided by the at least one sensor.

23. A method of cultivating a cannabis plant in a simulated high-altitude environment, said method comprising:
providing the simulated high-altitude controlled atmosphere room of claim 21;
germinating and/or growing a cannabis plant on the plant support structure in the chamber;
actively monitoring the microclimate conditions within the chamber via the sensor; and
automatically controlling the microclimate within the chamber based on one or more sensed microclimate conditions provided by the at least one sensor to establish and maintain within the chamber, for a treatment period of 5 days to 6 months, a nitrogen (N2) environment having a carbon dioxide (CO2) content of from 600 to 3000 ppm, and an oxygen (O2) partial pressure of from 5 to 15 kPa.

24. The method of claim 23, wherein automatically controlling the microclimate within the chamber comprises: supplying nitrogen (N2) to the chamber to reduce the oxygen (O2) partial pressure therein.

25. The method of claim 24, wherein the cannabis plant is grown in the chamber under the simulated high-altitude environment during a flowering stage, and wherein the method prepares a cultivated cannabis plant in a higher yield, by weight, as compared to a substantially similar cannabis plant cultivated without exposure to the simulated high-altitude environment.
